(19) United States
(12) Patent Application Publication
(10) Pub. No.: US 2009/0172973 A1
(43) Pub. Date: Jul. 9, 2009

(54) ENVIRONMENTAL-PROTECTION SHOE SOLE MADE OF RECYCLED SHOES

(76) Inventor: HAN-CHING WU, Taichung (TW)

Correspondence Address: LEONG C LEI, PMB # 1008, 1867 YGNACIO VALLEY ROAD, WALNUT CREEK, CA, 94598, US

(21) Appl. No.: 11/968,662

(22) Filed: Jan. 3, 2008

(51) Int. Cl. A43B 13/00; A43D 43/00; B29D 31/50

(52) U.S. Cl. 36/103; 36/25 R; 12/18.5; 12/21

(57) ABSTRACT

An environmental-protection shoe sole made of recycled shoes is provided, which uses recycled used shoes as a primary constituent of the raw material thereof, which used shoes, after being processed to remove metal accessories, are pulverized to small pieces of a predetermined size, and are then subjected to heating for deodorization and drying and thereafter added with a suitable amount of a base rubber, followed by uniformly mixing, to provide a shoe sole material, which is then molded and shaped. Thus, manufacturing time and material costs can be substantially reduced and environmental and economic effects by cyclic utilization of recycling used shoes can be realized.

### BACKGROUND OF THE INVENTION

(a) Technical Field of the Invention

The present invention provides an environmental-protection shoe sole made of recycled shoes, which allows for directly collecting used or discarded shoes with the sales of new shoes, and wherein the collected used shoes are processed to form a raw material of small pieces of particles of a suitable size, which raw material is then subjected to high temperature deodorization and drying and is further mixed, in a suitable ratio, with natural rubber or artificial rubber, added and mixed with constituents including curing additives and activating prompting agents, which constituents are mechanically and uniformly mixed and stirred to provide rough raw material having desired properties, which is further subjected to plate pressing to form raw material sheet for being ready to mold and shape a desired shoe sole, and is further received in a mold for heating and pressurizing for curing and shaping to thereby complete the making of the shoe sole whereby acquiring and manufacturing of material for shoe sole are ensured and non-public-pollution environmental-protection use can be realized and wherein the composition ratio of the constituents of the shoe sole can be modified in accordance with the desired property of the shoe sole and consequently, reduction of manufacturing costs and practical effectiveness can be achieved.

(b) Description of the Prior Art

Due to industrialization, consumption and waste of natural resources become severe. Further due to the fact that the natural resources are limited and regeneration thereof is difficult, lacking of all sorts of natural resources for industrial manufacturing becomes significant, making the manufacturing costs of all kinds of industrial products increased and the environment damaged, thereby leading to abrupt change of various living conditions associated with whole ecological surroundings and the atmosphere. This makes environmental protection an urgent issue for the modern people of the twenty-first century. Consequently, various environmental-protection-oriented products have being developed. However, under the prerequisite of causing no damage to the environment, the most up-to-date concept of environmental protection also emphasizes recycling and reuse of resources so that the resources and substances can be repeatedly and cyclically reused and regenerated, lowering the consumption and waste of energy and substances to seek for a opportunity for the Earth to take a beak and restoration, aiming to permanent protection of the Earth. In the respect of the series of management of merchandise including production, sales, and after-use processing, a design of product can be considered environmental-protection merchandise, if most of the materials and parts can be recycled for reuse or regeneration. Taking shoes as an example, the materials or parts used in a shoe include a variety of types of parts including a sole, a vamp, and a shoestring, which are all made different materials or are manufacturing with different conditions. In addition, footwear for different applications needs different properties, and this certainly needs the use of various materials, especially for the prerequisite of comfortableness, which leads to the manufacturing of shoe with combinations of various newly developed rubbers or artificial rubbers. In the respect of shoe sole, due to the requirement of different properties for different types of shoes, mixture or combination of different materials or substance with different ratios is employed to meet the requirements of use related to durability, comfortableness and cushioning. Due to such a limitation to the use of shoes, a general shoe sole is often manufactured with a primary constituent provided by primitive natural substances and heretofore, no used shoe has been used as the material for making the shoe sole. This is certainly not in compliance with the needs of environmental protection for recycling and reuse. Due to the raising of environmental-protection-oriented consumption, various sorts of she sole structures featuring environmental protection have been developed. Most of the commonly seen environmental-protection shoe soles are made of pulps or paper-based materials or filling of chippings of cork or natural substances including recycled plant material or husks, which are mixed with various additives or adhesives to fulfill the requirements of rigidity and water-resistance in actual applications. The mixture is further subjected to various processing including laminating or pulverization, stirring and molding, and cutting to complete the formation of shoe sole. The processing steps or steps of laminating are of a substantial number and a large amount of primitive natural rubber or artificial rubber is added in the material mixture before a shoe sole can be finally made. The overall manufacturing costs are apparently very high and most importantly, no improvement or effectively handling for management or recycling of used shoes is achieved. In addition, the used shoes in general are not considered valuable for traditional recycling. Consequently, it is difficult to overcome the garbage quantity control problem for used shoes. This is even truer for general consumers often have more than one pair of shoes, which leads to severer problem of potential environmental pollution and after-use handling. This is an issue to be addressed by the modern people. It would be a true environmental protection design if used shoes can be processed to serve as raw material for making new shoe soles to realize the idea of simultaneously collecting and recycling used shoes when new shoes are being sold. In respect of the development of shoe sole material in the viewpoint of environmental protection chain, recycling and converting used shoes into original material for making shoes is of a promising future of the effectiveness generated in protecting environments. It is believed that based on the recycling and reuse of used shoes, the manufacturing chain of footwear can be of the features of true environmental protection, reduced costs, and repeated use to provide long term value of use of environmental protection materials.

### SUMMARY OF THE INVENTION

The primary purpose of the present invention is to provide an environmental-protection shoe sole made of recycled shoes, which uses recycled used shoes as a primary constituent of the raw material thereof, which used shoes, after being processed to remove metal accessories, are pulverized to small pieces of a predetermined size, and are then subjected to heating for deodorization and drying and thereafter added with a suitable amount of a base rubber, followed by uniformly mixing, to provide a shoe sole material, which is then molded and shaped. Thus, manufacturing time and material costs can be substantially reduced and environmental and economic effects by cyclic utilization of recycling used shoes can be realized.

The applicant, being aware of the drawbacks of high costs and complicated manufacturing technology for the development, manufacturing and use of the currently available environmental-protection shoe soles, has been devoted himself in testing and development on the basis of years' experience in environmental protection related development and search for manufacturing footwear to thereby develop and provide a shoe sole made of recycled shoes, which is made of a material having a primary constituent provided by recycled shoes with metal accessories of the recycled shoes removed in advance before the recycled shoes are pulverized to small pieces or particles of a predetermined size. The small pieces are then stirred and is further subjected to high temperature deodorization and drying to provide a recycled raw material, which, depending on the desired properties of the footwear to be made, is added with suitable amounts of a base rubber and additives, followed by uniformly mixing. Based on the shoe sole manufacturing process taken, the mixture is further added with chemicals of additives and curing agents, followed by uniformly mixing and then poured into a mold for curing and molding in high temperature and high pressure, and then further subjected to trimming operation to form a recycled environmental-protection shoe sole having the desired properties. The manufacturing process is simple and can be conducted in a continuous manner with the result of substantial reduction of costs. Thus, the impracticability of at least high manufacturing costs for the currently available environmental protection shoe sole can be overcome.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1, which shows a flow chart of a manufacturing processed used to make an environmental-protection shoe sole made of recycled shoes.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

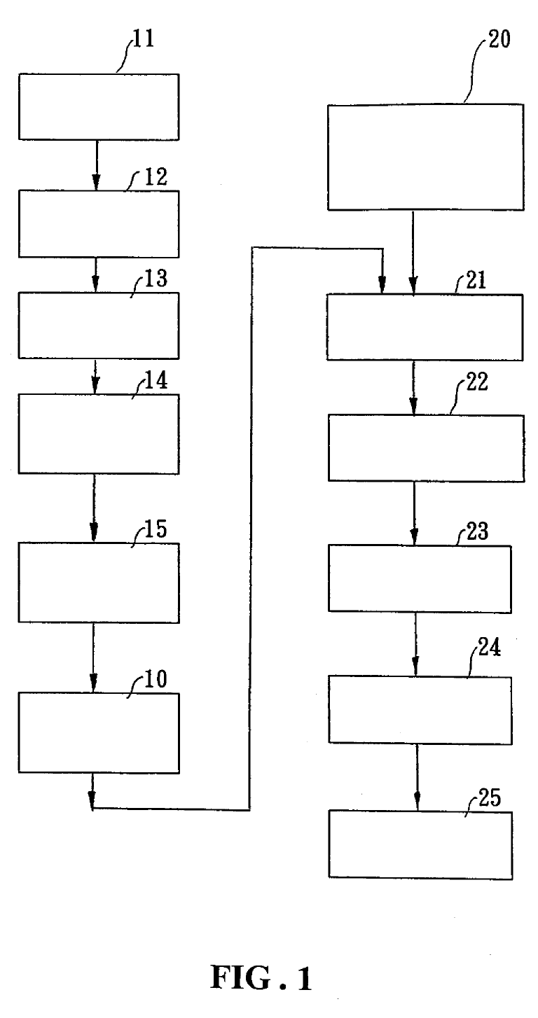

The present invention provides an environmental-protection shoe sole made of recycled shoes. The manufacturing of the environmental-protection shoe sole will be described with reference to the flow chart illustrated in FIG. 1. The environmental-protection shoe sole, which features full recycling, is made of a raw material (10), which comprises a recycled main body comprised of used and discarded recycled shoes 11, including general used sports shoes, leather shoes, work shoes, informal footwear, which can be any type of broken and discarded shoes, and both indoor and outdoor shoes can be recycled and used in the present invention. These recycled shoes do not need to be subjected to classification or other specific processing and only the metal accessories of the recycled shoes 11 need to be first subjected to a detaching/removing process (12). These metal parts or portions are subjected to separate recycling and processing. The shoes (11) are then fed into pulverization machinery for pulverization processing (13) to allow the shoes to be broken into small pieces of a size around 5 mmΦ, no limitation to the shape being required. Theses small pieces are then fed through a nearly enclosed tunnel-like conveying device and are subjected to high-temperature deodorization processing (14) at a temperature above 110° C. so that the recycled and pulverized shoes are so processed to be relatively cleaned and free of odors. Then, processing by hot air drying (15) is taken to finally form pulverized, well-mixed environmental-protection shoe sole raw material (10).

The shoe sole raw material (10) made of the recycled shoes (11) is prepared with a suitable percentage of weight, which is generally between 5-90%, for mixing with, depending on the physical properties desired for the shoe sole to be made, a base rubber (20) that is formed by mixing together natural rubber, artificial rubber additives, filling agents, which takes a ratio of 5-90%, and is disposed in a tank to be mechanically stirred and mixed (21) to meet the desired requirements of uniform mixture of which the mixture ratio is modified in accordance with the desired property of the shoe sole so made, by properly adding, among a total amount, 5-10% additives, including bridging agents, prompting agents, activating agents, aging-preventing agents, processing facilitating agents, in order to facilitates plate pressing realized by a planar rolling machine (22) to thereby form a plate-like material for molding shoe soles. With proper addition of the additives, the plate-like material can be rolled to form a roll of raw material sheet to facilitate subsequent trimming and storage. The thickness of the sheet is around 1-50 mm, and can be varied in accordance with the actual applications.

In making a shoe sole, the mixed and rolled material sheet is cut to a desired size and is then positioned in a molding device for molding processing (23), which is subjected to pressurization and heating by a hydraulic machine to be cured and shaped (24) thereby forming the desired shape of the shoe sole. The shoe sole raw material in accordance with the present invention has been tested and inspected and results of tests are listed in Attachment I of the application, which reveal that the mixed, environmental-protection, recycled raw material (10) takes a percentage of 50% of the material that makes the completed shoe sole, the remaining composition being the additionally incorporated base rubber (20) in the percentage of around 45%, together with additives, such as sulfur for facilitating curing of rubber, and rubber curing prompting agents, which together take a percentage of approximately 5% and, after being mixed in a suitable ratio, is directly mixed with the raw material and uniformly stirred for being further subjected to plate pressing processing (22) to form a roll of sheet material that facilitates stacking and winding for subsequent molding and/or cutting operation. Sheets of suitable size of the raw material (10) is disposed, in a quantitative manner, in the mold for molding processing (23) by clamping together upper and lower mold members to thereby allow for proceeding of heating and pressurizing for curing and shaping processing (24). With the assistance for curing provided by the sulfur additives and the activation caused by the curing prompting agents that are mixed in the raw material (10), the flowability of the raw material can be significantly enhanced to completely fill the internal volume of a mold cavity to complete the shaping of a shoe sole. The temperature of heating for general shoe soles is around 100-160° C. within a time period of 4-15 minutes. As to the mixing ratios of the compositions of the raw material, in accordance with the desired properties of the actually made shoe sole the mixing ratio of raw material can be made different. A semi-finished product of the molding operation, after being removed from the mold, is subjected to trimming operation to provide an edge-trimmed and neat edge of the molded shoe sole. As such, an integrally formed environmental-protection shoe sole product (25) is thus completed.

The environmental-protection shoe sole is primarily made of a material obtained from recycled shoes, wherein both indoor shoes or outdoor shoes can be simply recycled and used, and wherein, depending op the requirement of applications of the so made shoe sole, the mixing ratio of the constituent components can be modified and can be further modified by adding filling agents and can be selectively further processed for contact enhancing, namely further mixing the raw material (10) with 5-10% filling agent, such as the substances of Koalin, calcium carbonate, and glass powder, of which the ratios can be modified by adjustment of the amounts added in accordance with the requirements for hardness whereby reinforcement of properties in association with wear-resistance and being rigid can be realized, making the shoe sole more practical. This is similar to the manufacturing of the existing shoe sole and is not the novel part of the present invention, so that no further detail is needed herein. The features of the present invention are that the environmental-protection raw material (10) is made of a primary constituent component obtained from recycled used shoes, which, with only the metal accessories removed from the shoes, can be disposed in processing machinery for pulverization (13), leading to the effectiveness of saving labor and simplifying the operation of the manufacturing process and further realizing environmental conservation by recycling and re-using shoes. The whole process adds only minor extra costs and processing steps and continuous production with a manufacturing line can be realized for the manufacturing thereof, whereby the effectiveness of environmental-protection recycling, simplification, practicability can be achieved and importantly, the troublesome process that the conventional shoe recycling can only process a portion of the shoes and requires classifications of shoe parts is overcome. In the respect of shoe sole manufacturing, the present invention is advantageous in saving labor with a practical and economic structure, and achieves real environmental protection for sustainable recycling and reusing and complete regeneration.

In the above manufacturing of the environmental-protection shoe sole, the whole raw material (10) is obtained from arbitrary shoes that are discarded and recycled, together with a suitable amount of base rubber (20) mixed together to provide the desired properties and, after being used and discarded, can be repeatedly recycled and reused for pulverization for subsequent processing, ensuring an environmental-protection raw material that can be cyclically and repeated regenerated. Thus, the whole manufacturing process of the shoe sole is completely done with environmentally conservative and pollution-free constituents, selectively combined with suitable amounts of curing additives and flowability prompting agents. Such additives are of minor amounts and are generally volatile substance in the curing process so that they are completely of no problems of influencing after-discarding recycling and processing of the shoe sole. The whole manufacturing process can be done in a continuously producing manner, requiring no particular processing technology, and can be planned and controlled with automatic manufacturing lines so that the manufacturing is automatized and continuous, and there is no needed to do manufacturing in segmentized process with additional interconnection therebetween. That is to say that the present invention provides a combination and design of shoe sole material that is of extreme novelty. A conservative estimation indicates that the overall manufacturing cost is reduced at least 15% as compared to conventional manufacturing of shoe sole. As to the respects of environmental conservation and economic values for recycling and reusing of the discarded shoes, the present invention is novel and environmental conservation manufacturing and design of shoe sole, which is apparently unprecedented and of economic values and offers a true value that is beyond comparison by the currently existing environmental protection shoe soles.

To summarize, the present invention offers an environmental protection shoe sole that is made of recycled shoes by using the recycled shoes in an intact manner for pulverization, regulation, and mixing for subsequent processing, together with a suitable amount of base rubber, followed by adjustment and shaping, to thereby allow the shoe sole to be unlimitedly recycled and reused with the least amount of material lost and actually providing the features of use of environmental protection substances. In the respect of material development and design, the present invention offers the advantages of reduction of manufacturing costs, simplification of manufacturing process, and enhancement of practical value.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An environmental-protection shoe sole made of recycled shoes, the shoe sole being manufactured by steps of mixing and stirring raw materials, molding and shaping, and trimming, characterized in that the raw material is comprised of a primary constituent of recycled shoes, which, after being subjected to removal of metal accessories, is disposed in processing machinery for pulverization to be small pieces of a size of 5 mmΦ, followed by high temperature deodorization for cleaning the recycled shoes and is further subjected to hot air drying to form pulverized and uniformly-mixed environmental-protection shoe sole raw material.

2. The environmental-protection shoe sole made of recycled shoes as claimed in claim 1, wherein the high temperature deodorization comprises feeding the material into an enclosed tunnel-like conveying device and subjecting the material to high temperature steam deodorization at a temperature approximately or above 120° C.

3. The environmental-protection shoe sole made of recycled shoes as claimed in claim 1, wherein the recycled shoes include indoor shoes, outdoor shoes, and any other shoes.

4. The environmental-protection shoe sole made of recycled shoes as claimed in claim 1, wherein the pulverized recycled shoes take an amount of 5-90% of the shoe sole raw material.

5. An environmental-protection shoe sole made of recycled shoes, the shoe sole being manufactured by mixing and stirring raw materials, molding and shaping, and trimming, characterized in that recycled shoes are used as primary constituent, which, after removal of metal accessories, is processed, by being subjected to pulverization, particles deodorization, drying, to form a raw material, which takes an amount of 5-90% of shoe sole material and is further mixed with a suitable amount of a base rubber in an amount of 5-90% and further added with suitable amounts of 5-10% of additives, followed by mechanically and uniformly mixed and stirred, processed by a planar rolling device to be rolled to form sheet-like environmental-protection shoe sole material for being ready to cut and positioned in a mold for molding by being heating and pressurized by a hydraulic device for curing and shaping to thereby form a shoe sole of environmental-protection material.

6. The environmental-protection shoe sole made of recycled shoes as claimed in claim 5, wherein the sheet-like shoe sole material that is formed by processing a mixed and stirred material of the pulverized constituent is of a thickness of 1-50 mm.

7. The environmental-protection shoe sole made of recycled shoes as claimed in claim 1, wherein in mixing and stirring the shoe sole sheet material, the material is added with filling agents including Kaolin, calcium carbonate, and glass powder to offer rigid properties of the sheet material.

8. The environmental-protection shoe sole made of recycled shoes as claimed in claim 7, wherein the filling agents are of an amount of 5-10% of the stirred material.
